(19) United States
(12) Patent Application Publication
(10) Pub. No.: US 2021/0236972 A1
(43) Pub. Date: Aug. 5, 2021

(54) FILTER MEDIUM COMPRISING A REINFORCED NON-WOVEN FABRIC

(71) Applicant: SGL CARBON SE, Wiesbaden (DE)

(72) Inventors: Almut SCHWENKE, Meitingen (DE); Manfred JUNG, Meitingen (DE); Oswin OETTINGER, Meitingen (DE); Rainer SCHMITT, Meitingen (DE)

(73) Assignee: SGL CARBON SE, Wiesbaden (DE)

(21) Appl. No.: 16/972,758

(22) PCT Filed: Jun. 6, 2019
(86) PCT No.: PCT/EP2019/064888

§ 371 Date: Dec. 7, 2020

(30) Foreign Application Priority Data
Jun. 8, 2018 (DE) 10 2018 209 200.1

(51) Int. Cl. B01D 39/16; B01D 39/08; B32B 5/02; B32B 5/26; D04H 1/4242; D04H 1/43; D04H 1/4374; D04H 1/498

(52) U.S. Cl. CPC B01D 39/1623; D10B 2505/04; B32B 5/022; B32B 5/024; B32B 5/275; B32B 5/277; D04H 1/4242; D04H 1/43; D04H 1/4374; D04H 1/498; B01D 2239/1233; B01D 2239/1291; B01D 2239/1258; B01D 2239/10; B01D 2239/0618; B01D 2239/0613; B01D 2239/0663; B32B 2250/20; B32B 2255/02; B32B 2262/0246; B32B 2307/724; B32B 2307/718; B32B 2307/306; B32B 2307/202; B01D 39/086

(57) ABSTRACT

The invention relates to a filter medium comprising a reinforced non-woven fabric, to a method for the production thereof, and to the use thereof.

The present invention relates to a filter medium comprising a reinforced non-woven fabric, to a method for the production thereof, and to the use thereof.

Reinforced non-woven fabrics are used in many areas. One field of application is the use of filters, for example for dust separation in various industries such as waste incineration, the coal and power plant industry, in mining, casting applications or graphite production. The filter media used can consist of a plurality of layers, for example three layers, which are connected to one another by mechanical solidification (e.g. needling or hydroentanglement). The following three layers are mentioned by way of example: 1) a first non-woven layer as a filter layer, 2) a reinforcement layer, for example a fabric insert, for mechanical reinforcement, in particular for cleaning by means of a blast of compressed air, 3) a second non-woven layer as a protective layer for the reinforcement layer. Important parameters of a filter medium are the dust separation performance, the pressure loss, and the mechanical, chemical and thermal resistance of the material.

For demanding conditions, textile filter media made of polymeric high-performance fibres, in particular polytetrafluoroethylene (PTFE, Teflon), m-aramid and polyimide are used. Due to the thermal resistance thereof, these filter media can only be used up to approx. 260° C. PTFE has a slightly higher thermal resistance, but is not used at temperatures higher than 260° C. due to the development of toxic gases and due to the strong creep, which leads to mechanical failure of the filter medium

In order to be able to use textile filters at a temperature higher than 260° C., for example in the event of possible temperature peaks, a reinforced non-woven fabric that can withstand temperatures of more than 260° C. is sought. This applies both to the non-woven layer(s) and to the reinforcement layer of the reinforced non-woven fabric.

Static charging of non-conductive filter media can lead to spark formation and flying sparks, which in turn can damage the filter structure. Thermal hotspots can also lead to such damage. There is thus a need for a reinforced non-woven fabric which has at least one thermally and/or electrically conductive layer.

Reinforced non-woven fabrics are also used to filter liquid substances. Important parameters in this case are in particular the chemical resistance and the corrosion resistance of the reinforced non-woven fabrics used. One field of application in which chemical resistance is critical is the filtering of strongly acidic or strongly alkaline substances.

The object of the present invention is therefore to provide a filter medium which can be used in particular at temperatures greater than 260° C. Furthermore, this filter medium should be electrically and/or thermally conductive, it should have chemical resistance and corrosion resistance, and it should not be flammable. In addition, the filter medium should be suitable for filtering gases as well as liquids.

In the scope of the present invention, this object is achieved by providing a filter medium comprising a reinforced non-woven fabric, wherein the non-woven fabric has at least one non-woven layer based on preoxidised polyacrylonitrile (PAN) and at least one reinforcement layer, wherein the reinforcement layer has a first side and a second side, and wherein the reinforcement layer is covered from the first side and/or the second side by the at least one non-woven layer.

According to the invention, it was recognised that if at least one non-woven layer of the reinforced non-woven fabric is based on preoxidised PAN, the non-woven fabric—and thus also the filter medium—has a temperature resistance of greater than 260° C. This property is reinforced if a further temperature treatment of the preoxidised PAN is takes place with the exclusion of oxygen under protective gas. Carbonised PAN or partially carbonised PAN can be formed during this temperature treatment. In addition, the reinforced non-woven fabric—and thus the filter medium—can then have a higher electrical and thermal conductivity than known filter materials. The preoxidised PAN, the carbonised PAN or the partially carbonised PAN is preferably used in the form of fibres, the carbonised PAN then being in the form of carbon fibres.

Carbonised or partially carbonised reinforced non-woven fabrics are not only characterised by the media resistance thereof but also by the electrical conductivity thereof. Therefore, they can also be used as electrode material for electrochemical processes such as energy storage or electrolysis. The textile structure of the non-woven fabric can be adapted by selecting the method and the production parameters. Compared to other common electrode materials, reinforced textiles based on carbon fibres can be produced relatively cost-effectively as rolled goods.

PAN is the polymer of acrylonitrile and is often used as a textile fibre. It can be in the form of a homopolymer or in the form of a copolymer. Copolymers usually contain acrylonitrile in a proportion of more than 85% and a comonomer such as methyl methacrylate or vinyl chloride.

Preoxidised PAN means that a temperature treatment of PAN has taken place in the presence of oxygen at typically 200-300° C. Further terms for preoxidised PAN are thermally stabilised PAN or oxidised PAN. Preoxidised PAN is a fibre which is commercially available, for example, as PANOX® by SGL TECHNOLOGIES GmbH. PANOX® is an oxidised, thermally stabilised polyacrylonitrile (PAN) fibre, which due to the chemical structure thereof does not burn, melt, soften or drip. With an LOI value (limiting oxygen index) of over 50%, preoxidised PAN is significantly higher than other organic fibres and corresponds to burning class S-a according to DIN 66083. Flammability is when a substance continues to burn after it has caught fire, even if the ignition source is removed. Furthermore, preoxidised PAN has a high temperature resistance and a high chemical resistance. The carbon content of the preoxidised PAN is typically between 60% and 65%.

Partially carbonised PAN means that preoxidised PAN is subjected to a temperature treatment under protective gas between 300° C. and 1000° C. The carbon content of partially carbonised PAN is in a range from more than 65% to less than 92%. If preoxidised PAN is subjected to a temperature treatment under protective gas at more than 1000° C., a carbonised PAN, i.e. carbon fibres, is created, which has a carbon content of more than 92%.

Instead of PAN, in particular PAN fibres, cellulose fibres can also be used as precursors for the production of carbonised fibres or partially carbonised fibres (carbon fibres). These cellulose-based fibres can also be contained in at least one non-woven layer and/or at least one reinforcement layer of the reinforced non-woven fabric of the filter medium. It is also possible to use carbonised or partially carbonised fibres, for the production of which a mixture of preoxidised PAN fibres and cellulose fibres is used.

The filter medium according to the invention can be used for filtering both gases and liquids.

The filter medium according to the invention preferably has a flat or round shape. The round shape can be in the form of a tube, a hose or a cylindrical shape (hollow cylinder).

According to one embodiment of the present invention, the at least one reinforcement layer of the reinforced non-woven fabric of the filter medium is a woven fabric, a scrim, a knitted fabric, a crocheted fabric, a meshwork or a grid, it being possible for these reinforcement layers to be produced making use of continuous fibres (filaments) or yarns. This type of reinforcement layer increases the mechanical resistance of the reinforced non-woven fabric. When using at least one such reinforcement layer, in particular in the form of a meshwork, a knitted fabric or a crocheted fabric, the reinforced non-woven layer can be designed in a round, stretchable or resilient shape that allows the filter medium to be used more easily. For example, this resilient filter medium can be slipped over support structures more easily or shrunk on as a carbonised or partially carbonised reinforced non-woven fabric by means of temperature treatment. The extensibility is an additional advantage in the production of the carbonised or partially carbonised filter medium, since the shrinkage of the non-woven layer can be evened out better during the carbonisation or partial carbonisation.

Woven fabrics and scrims are produced from continuous fibres or yarns. In the case of scrims, the fibre strands are deposited and then woven using a thread cord or else glued with a plastics material. The fibres can all be aligned in one direction (unidirectional) or as a multi-layer system in which the different layers are deposited at defined angles (multiaxial).

Woven fabrics consist of thread systems crossed at right angles (warp and weft). Various types of weave, such as plain weave or twill weave, are possible with which the strength, drapability or surface structure can be adjusted.

Braided structures are produced by regularly crossing a plurality of fibre strands or yarn strands. In contrast to weaving, the threads are not fed at right angles to the main product direction.

Crocheted fabrics and knitted fabrics are flat textiles that are also known as knitwear and are characterised by their flexible and resilient structure. Crocheted fabrics are produced by stitch formation from horizontally placed single threads. In the case of knitted fabrics, single threads are also used—but the stitch formation takes place by needles moving at the same time.

A net-like knitted fabric is typically referred to as a grid. Fine or coarse-meshed nets or knitted fabrics with different structures are possible. Grids are further described via the orientation of the individual ribs, the enclosed hole area, the respective angle of the ribs to one another and the width of the ribs. All forms are possible as reinforcement within the scope of the invention.

According to a further embodiment of the present invention, a material of the reinforcement layer of the reinforced non-woven fabric of the filter medium is a material selected from the group consisting of glass fibres, basalt fibres, metal fibres, metal wires, preoxidised PAN fibres, carbonised PAN fibres (carbon fibres) or partially carbonised PAN fibres. Preoxidised PAN fibres, partially carbonised PAN fibres or carbon fibres, more preferably partially carbonised PAN fibres or carbon fibres, particularly preferably carbon fibres, are used as the material for this reinforcement layer. The materials mentioned have the advantage that they are temperature-resistant, even at temperatures greater than 260° C., and that they have a high chemical resistance. If metal fibres or metal wires are used as at least one reinforcement layer of the reinforced non-woven fabric, pleated filter structures can be produced.

The filter medium according to the invention containing a reinforced non-woven fabric preferably comprises at least one non-woven layer based on preoxidised PAN, which has been carbonised or partially carbonised, preferably partially carbonised. In this case, a material of the reinforcement layer of the reinforced non-woven fabric of the filter medium is a material selected from the group consisting of glass fibres, basalt fibres, metal fibres, metal wires, preoxidised PAN fibres, carbonised PAN fibres or partially carbonised PAN fibres (carbon fibres). The inventor has carried out a series of tests with reinforced non-woven fabrics in which at least one non-woven layer is carbonised PAN. It was found in this case that these embodiments according to the invention have a significantly higher temperature resistance than known polymer high-performance fibres such as PTFE, m-aramid or polyimide. During the use of such a filter medium according to the invention at higher temperatures, in particular at temperatures of at least up to 260° C., it is possible to filter the medium to be filtered (gas or liquid) at temperatures of at least 260° C. and to subject said medium to a catalysis process (e.g. denitrification) after or during the filtering process. This catalysis process typically requires higher temperatures than the temperature resistance of common filter materials. For this reason, up to now the filter medium had to be cooled for filtration and warmed up again for denitrification. With the non-woven fabric according to the invention, this cooling and warming step is omitted, whereby an energy saving can be achieved. In addition, the filter medium according to the invention can advantageously be used as a filter in front of a heat exchanger, since the filter can prevent contamination of the heat exchanger and thus improve the service life thereof and the efficiency thereof.

Preoxidised PAN, which has been at least partially carbonised, preferably carbonised, also preferably represents the reinforcement layer of the reinforced non-woven fabric of the filter medium according to the invention, so that at least one non-woven layer and at least one reinforcement layer of the reinforced non-woven fabric are made from partially carbonised PAN, preferably from carbonised PAN (carbon fibres). This allows the reinforced non-woven fabric to have high electrical and thermal conductivity. Since at least one non-woven layer and the at least one reinforcement layer are both carbonised, the reinforcement layer is also temperature-resistant at higher temperatures, which allows that the storing of the reinforced non-woven fabric in air at 280° C. in 5 days leads to a mass loss of at most 5%. Furthermore, the filter medium has a very high chemical resistance and is extremely corrosion-resistant. Furthermore, this filter medium is not flammable and has no visible creep behaviour.

The reinforced non-woven fabric of the filter medium according to the invention preferably has at least two non-woven layers which are arranged on the first side (one side) of the reinforcement layer, each of these non-woven layers being produced from a different material and thus having different properties. For example, if two such non-woven layers are used, one non-woven layer can be produced from fibres having a larger average diameter than the fibres of the other non-woven layer, or both non-woven layers have different densities. When such a reinforced non-woven fabric is used in a filter medium, these different non-woven layers can be used to filter different components and to control the depth of particle penetration into the non-woven fabrics.

According to a further preferred embodiment of the present invention, at least one non-woven layer and/or at least one reinforcement layer, preferably at least one non-woven layer, of the filter medium can have an active component. The active component can be, for example, a catalyst and/or an activated carbon. Activated carbon is a carbon material with a high specific surface. This can be used to adsorb pollutants such as mercury or poisonous organic solvents, or as a carrier for catalysts. The active component can add chemical adsorption or reactive, catalytic cleaning to mechanical filtration through a combinatorial effect. For example, the filtration of flue gas can be combined with catalytic denitrification. Due to the structure of the non-woven layer, the retention time of media (e.g. liquids or gases) in the filter can also be controlled in order to generate the necessary reaction time for the catalytic reaction.

If fibres, preferably preoxidised PAN fibres, are used for the production of the non-woven layers or reinforcement layers, these fibres have an average fibre diameter that is in a range from 200 nm to 35 μm, preferably in a range from 300 nm to 30 μm, particularly preferably in a range from 400 nm to 25 μm, most particularly preferably in a range from 500 nm to 20 μm. Carbon fibres typically have an average fibre diameter of 5 to 10 μm. The average fibre diameter is determined by measuring with the aid of a microscope. The separation performance can be controlled via the average fibre diameter.

In yet another preferred embodiment of the present invention, the reinforced non-woven fabric of the filter medium has at least one electrically conductive non-woven layer and/or at least one electrically conductive reinforcement layer, and is configured such that an electrical discharge and/or a heating of the filter is made possible by applied electric current. During use as a filter, the discharge can be made possible in that the filter has an electrical connection to the reinforced non-woven fabric for electrically discharging the non-woven fabric. This prevents electrical charging of the reinforced non-woven fabric and reduces possible flying sparks, which can have a damaging effect on the filter structure. The heating can be made possible in that the filter has an electrical heating circuit for heating the reinforced non-woven fabric by means of an electric current conducted through the reinforced non-woven fabric. The heating of the reinforced non-woven fabric allows the filter to be cleaned. Furthermore, the heating can limit or prevent contamination from condensation of components. Furthermore, the filter can also be used to heat the medium to be filtered, for example for liquids. At least one non-woven layer and at least one reinforcement layer are both advantageously electrically conductive. This electrical conductivity means that the reinforced non-woven fabric can be used not only in a filter medium, but also as an electrode.

The reinforced non-woven fabric of the filter medium according to the invention preferably has a tear strength of at least 10 dN/5 cm, preferably of at least 50 dN/5 cm, particularly preferably of at least 100 dN/5 cm and/or an air permeability of at least 20 L/(dm²*min) and at most 1000 L/(dm²*m) at 200 Pa. The tear strength is determined in accordance with DIN EN 29073-3:1992-08 (test method for non-woven fabrics, part 3). This tear strength leads to an increase in the mechanical stability of the filter medium, since there is increased dimensional stability and it leads to a longer service life, since more cleaning cycles can be carried out. The air permeability is determined in accordance with DIN EN ISO 9073-15:2008-08 (test method for non-woven fabrics, part 15).

According to a further embodiment of the present invention, the reinforced non-woven fabric of the filter medium comprises at least one non-woven layer having a surface mass of at least 50 g/m² and at most 1000 g/m² and/or at least one reinforcement layer having a surface mass of at least 25 g/m² and at most 1000 g/m². The thickness of the filter medium can be between 0.2 mm and 10 mm. The surface weight is determined in accordance with DIN EN 29073-1:1992-08 (test method for non-woven fabrics, part 1) and the thickness is determined in accordance with DIN EN ISO 9073-2:1997-02 (test method for non-woven fabrics, part 2).

According to yet another preferred embodiment of the present invention, a coating is applied to at least one non-woven layer of the filter medium. This coating can preferably be applied in the form of fibres, membranes or particles. The coating can be applied to one side or to both sides of the reinforced non-woven fabric. The coating can have fibres having a fibre diameter of 50 nm to 5000 nm, preferably from 200 nm to 1000 nm. If coating takes place with particles, these particles have an average particle size between 10 nm and 100 μm. The average particle size is determined by laser granulometry (ISO 13320). It can also be coated with a membrane, the thickness of the membrane being less than 100 μm. The coating preferably has a material selected from the group consisting of fluoropolymer fibres, PAN fibres, ceramic fibres, PTFE membranes, carbon black or other carbon particles such as graphite or ceramic particles. Applying a coating to at least one non-woven layer can lead to an increase in wear resistance and/or to a reduction in abrasion and also increase the degree of separation.

In the scope of the invention, it is possible that the individual named embodiments of the filter medium are combined with one another.

The filter medium according to the invention is suitable for filtering liquids or gases.

The filter media according to the invention, in particular the carbonised and partially carbonised media having a reinforcement layer selected from the group consisting of preoxidised PAN fibres, partially carbonised PAN fibres or carbon fibres, show very good chemical resistance in various media. For example, in inorganic and/or oxidising inorganic acids such as hydrochloric acid (37%), sulphuric acid (80%) or nitric acid (65%), as well as in alkaline media such as ammonia (28%), no attack or degradation of the filter media takes place. A weight loss after storage at room temperature or under reflux for 100 h shows no measurable decrease in weight.

Furthermore, the filter media according to the invention are very water and oil resistant. None of the filter media according to the invention show any measurable decrease in weight at room temperature or under reflux for 100 h. In particular, the oil resistance up to 200° C. is surprising. The filter media according to the invention are also suitable for refrigeration applications. Contact with media or cold mixtures in the temperature range down to −190° C. does not show any embrittlement or mechanical damage to the material, even after mechanical stress based on ISO 974 (Plastics—Determination of the brittleness temperature by impact).

In particular, the filter media according to the invention are suitable for filtering gases at a temperature of at least up to 260° C., wherein the filter medium is heat-resistant and non-flammable up to at least 260° C. or the filter media can be used to filter liquid substances, in particular chemically reactive substances.

The present invention also relates to a method for the production of the filter media according to the invention comprising the steps:
providing at least one non-woven layer based on preoxidised PAN and at least one reinforcement layer, wherein the reinforcement layer has a first side and a second side, and
solidifying the at least one non-woven layer based on preoxidised PAN with the reinforcement layer, so that the reinforcement layer is covered from at least one of the first side and/or the second side by the at least one non-woven layer.

The term “solidifying” describes the assembly of specific components to form a reinforced non-woven fabric making use of, for example, needling or hydroentanglement.

A temperature treatment can take place either before or after solidifying, preferably after solidifying.

Such a temperature treatment preferably takes place in a range from 260° C. to 900° C., more preferably in a range from 500° C. to 900° C. If a metal fibre or a metal wire is used for the production of the reinforcement layer, the temperature treatment advantageously takes place before solidifying. If, on the other hand, the same material is used for at least one non-woven layer and at least one reinforcement layer, the temperature treatment advantageously takes place after the solidifying.

With the method mentioned, the filter media according to the invention can be produced in a flat shape as well as in a round shape, such as a tube, a hose or a hollow cylinder.

The present invention will be described further on the basis of examples, which explain but do not limit the invention, with reference to the drawings.

### Embodiment

For the production of a filter medium, a flat, reinforced non-woven fabric was produced by using a grid as a reinforcement layer consisting of carbon fibres and having a surface weight of approx. 150 g/m². The ribs in the warp and weft directions had an angle of 90° and consisted of carbon fibres in both directions. The thread spacing (based on the centre of the ribs) was approx. 25 mm. The resulting grid opening/distance between the sides of the ribs was approx. 23 mm.

Furthermore, a non-woven layer consisting of preoxidised PAN (SGL-PANOX; 063-1.7/1.39-A110) was produced by hydroentanglement (PANOX) and then solidified on both sides of the above reinforcement layer by a water jet. A reinforced non-woven fabric having a surface weight of approx. 800 g/m², a thickness of 3.5 mm (measured on the grid ribs) and a tear strength of 60 dN/cm was obtained.

The drawings are schematic and serve to explain specific embodiments of the present invention.

In this regard, directional terms such as “first side”, “second side” etc. are used without reference to the orientation of the drawing(s) described. For a filter application, these terms are preferably, but not necessarily, described in connection with a possible flow direction of a substance to be filtered. Because components of embodiments can be positioned in a number of different orientations, the terms relating to direction are used for purposes of illustration only and should in no way be taken as limiting. In particular, in some embodiments there may be no “substance to be filtered” (for example, this could be when the non-woven fabric is used as electrode material). In such cases, descriptions such as “first side”, “second side” are to be understood as any orientation.

The drawings show different embodiments of the reinforced non-woven fabric according to the invention:

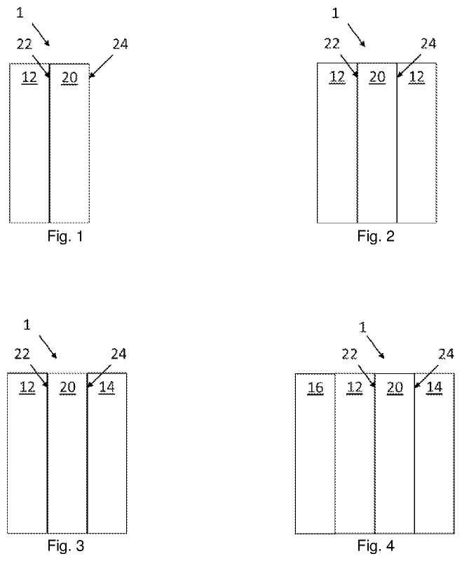

FIG. 1 is a cross section of a reinforced non-woven fabric according to one embodiment,

FIG. 2 is a cross section of a reinforced non-woven fabric according to a further embodiment,

FIG. 3 is a cross section of a reinforced non-woven fabric according to yet another embodiment,

FIG. 4 is a cross section of a reinforced non-woven fabric according to yet another embodiment.

The individual drawings are discussed in greater detail below.

FIG. 1 is a cross section of a reinforced non-woven fabric according to one embodiment. The reinforced non-woven fabric (1) has at least one non-woven layer (12) based on preoxidised PAN and a reinforcement layer (20). The reinforcement layer (20) has a first side (22) and a second side (24), wherein the reinforcement layer (20) is covered from at least one of the first side (22) and the second side (24) by the at least one non-woven layer (12). The first side (22) is preferably arranged towards a flow direction of a substance to be filtered and the second side (24) is arranged away from the flow direction of the substance to be filtered.

FIG. 2 shows a further preferred embodiment of the reinforced non-woven fabric, in which the reinforcement layer (20) is covered from both the first side (22) and the second side (24) by the at least one non-woven layer (12).

According to one embodiment, the reinforced non-woven fabric can have at least two non-woven layers (12, 14), wherein a first non-woven layer (12) can be arranged on the first side (22) of the reinforcement layer (20) and a second non-woven layer (14) can be arranged on the second side (24) of the reinforcement layer (20), as shown in FIG. 3.

FIG. 4 shows a further embodiment of the reinforced non-woven fabric which has at least three non-woven layers (12, 14, 16), at least two non-woven layers (12, 16) being arranged on the first side (22). In this case, each of the non-woven layers (12, 16) arranged on the first side (22) can have different material properties. When the reinforced non-woven fabric is used as a filter, each of the non-woven layers (12, 16) arranged on the first side (22) can be suitable for filtering different components. The non-woven layers (12, 16) arranged on the first side (22) can advantageously each be suitable for filtering components above a specific size. This makes it possible to filter the substance to be filtered gradually according to the size of the components.

### LIST OF REFERENCE SIGNS

1 reinforced non-woven fabric

12, 14, 16 non-woven layer based on preoxidised PAN

20 reinforcement layer

22 first side of the reinforcement layer

24 second side of the reinforcement layer

1-16. (canceled)

17. A filter medium comprising:
a reinforced non-woven fabric, wherein the non-woven fabric has at least one non-woven layer based on preoxidised polyacrylonitryl (PAN) and at least one reinforcement layer, wherein the at least one reinforcement layer has a first side and a second side, wherein the at least one reinforcement layer is covered from the first side and/or the second side by the at least one non-woven layer.

18. The filter medium according to claim 17, wherein the filter medium has a flat or round shape.

19. The filter medium according to claim 17, wherein the at least one reinforcement layer is a woven fabric, a scrim, a knitted fabric, a crocheted fabric, a meshwork or a grid.

20. The filter medium according to claim 19, wherein a material of the at least one reinforcement layer is selected from the group consisting of metal fibres, metal wires, preoxidised PAN fibres, partially carbonised PAN fibres or carbon fibres.

21. The filter medium according to claim 17, wherein the at least one non-woven layer based on preoxidised PAN and/or the at least one reinforcement layer based on preoxidised PAN is carbonised or partially carbonised.

22. The filter medium according to claim 17, wherein the reinforced non-woven fabric has at least two non-woven layers, wherein a first non-woven layer is arranged on the first side of the reinforcement layer and a second non-woven layer is arranged on the second side of the reinforcement layer.

23. The filter medium according to claim 17, wherein at least two non-woven layers are arranged on the first side of the reinforcement layer, wherein each of the non-woven layers arranged on the first side of the reinforcement layer has different material properties.

24. The filter medium according to claim 17, wherein at least one of the non-woven layers and/or at least one of the reinforcement layers has an active component.

25. The filter medium according to claim 17, wherein at least one of the non-woven layers comprises fibres having an average fibre diameter which is in a range from 200 nm to 35 μm.

26. The filter medium according to claim 17, wherein the reinforced non-woven fabric has at least one electrically conductive non-woven layer and/or at least one electrically conductive reinforcement layer, and is configured such that an electrical discharge and/or a heating of the filter is made possible by applied electric current.

27. The filter medium according to claim 17, wherein the reinforced non-woven fabric has a tear strength of at least 10 dN/5 cm, and/or an air permeability of at least 20 L/(dm²*min) and at most 1000 L/(dm²*min) at 200 Pa.

28. The filter medium according to claim 17, wherein the surface mass of the at least one non-woven layer is at least 50 g/m² and at most 1000 g/m² and/or the surface mass of the reinforcement layer is at least 25 g/m² and at most 1000 g/m².

29. The filter medium according to claim 17, wherein a coating is applied to at least one of the non-woven layers.

30. The use of a filter medium according to claim 17 for filtering gases, wherein the filter medium is suitable for filtering gases having a temperature of at least up to 260° C., and the filter medium is heat-resistant and non-flammable up to at least 260° C.

31. A method for the production of a filter medium according to claim 17, comprising the steps of:
providing at least one non-woven layer based on preoxidised PAN and at least one reinforcement layer, wherein the at least one reinforcement layer has a first side and a second side, and
solidifying the at least one non-woven layer based on preoxidised PAN with the at least one reinforcement layer, so that the at least one reinforcement layer is covered from at least one of the first side and/or the second side by the at least one non-woven layer.

32. The method for the production of a filter medium according to claim 31, wherein a step of temperature treating takes place before or after the step of solidifying, preferably after solidifying.
